(19) United States
(12) Patent Application Publication
(10) Pub. No.: US 2003/0120979 A1
(43) Pub. Date: Jun. 26, 2003

(54) Method and apparatus for remotely debugging an application program

(76) Inventors: Kuo-Chun Lee, Fremont, CA (US); Tsung-Yen Eric Chen, Fremont, CA (US); Ke-Qin Gu, Milpitas, CA (US)

Correspondence Address: VICTOR H. OKUMOTO, P.O. BOX 6120, FREMONT, CA, 94538, US

(21) Appl. No.: 10/355,800

(22) Filed: Jan. 31, 2003

Related U.S. Application Data
(63) Continuation-in-part of application No. 09/664,941, filed on Sep. 19, 2000.

(51) Int. Cl. H02H 3/05

(52) U.S. Cl. 714/38

(57) ABSTRACT

A method and apparatus for remotely debugging an application program over the Internet is described. A software vendor provides an interface program along with an application program to a customer. The interface program detects a debug request initiated by a customer operator on a customer computer, and establishes a connection with a debug program on a vendor computer over the Internet. The interface program takes over control of the application program from the customer operator, and takes various actions including running a diagnostic sequence received from the debug program on the application program to debug the application program.

### CROSS-REFERENCE TO RELATED APPLICATIONS

This application is a continuation-in-part of commonly-owned U.S. patent application Ser. No. 09/664,941, filed Sep. 19, 2000, and incorporated herein by this reference.

### FIELD OF THE INVENTION

The present invention generally relates to methods for software vendors to provide technical assistance to their customers and in particular, to a method and apparatus for remotely debugging an application program.

### BACKGROUND OF THE INVENTION

It is common business practice for customers to purchase application programs or software over the Internet by downloading them from vendor web sites. This method of purchasing software is both convenient for customers, and cost effective for vendors. Customers do not waste time or gas traveling to and looking for retail stores stocking the software, and vendors eliminate middleman expenses and avoid packaging and media costs.

Unfortunately, when customers experience problems using the purchased software, the prevalent method of debugging those problems continues to be the old fashioned method of calling in for customer telephone assistance. This approach results too often in long waits to talk to technical support personnel, and limited diagnostic assistance once such personnel become available since it may be difficult for them to replicate the customer's problem on their computers.

### OBJECTS AND SUMMARY OF THE INVENTION

Accordingly, objects of the present invention are to provide an improved method and apparatus for software vendors to provide technical assistance to their customers.

Other objects are to provide a method and apparatus for software vendors to provide technical assistance to their customers over the Internet.

Still other objects are to provide a method and apparatus for remotely debugging an application program in either foreground or background modes.

These and additional objects are accomplished by the various aspects of the present invention, wherein briefly stated, one aspect is a method for debugging an application program, comprising: (a) receiving a request from a debug program; (b) causing an application program to generate pixel information suitable for a display screen in response to the request; (c) storing the pixel information in a virtual frame buffer so as not to be displayed on the display screen; (d) generating a graphics file from the pixel information; and (e) transmitting the graphics file to the debug program for processing.

In another aspect, an apparatus for debugging an application program, comprises a first computer including an interface program configured to: (a) receive a request from a debug program; (b) cause an application program to generate pixel information suitable for a display screen of the first computer in response to the request; (c) store the pixel information in a virtual frame buffer of the first computer so as not to be displayed on the display screen; (d) generate a graphics file from the pixel information; and (e) transmit the graphics file to the debug program for processing.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 illustrates a diagram of a system for remotely debugging an application program over the Internet.

FIG. 2 illustrates a client display screen under control of an application program.

FIG. 3 illustrates a client display screen under control of an interface program.

FIG. 4 illustrates a flow diagram of a method implemented in a client computer for remotely debugging an application program over the Internet.

FIG. 5 illustrates a flow diagram of a method implemented in a server computer for remotely debugging an application program over the Internet.

### DETAILED DESCRIPTION OF THE PREFERRED EMBODIMENT

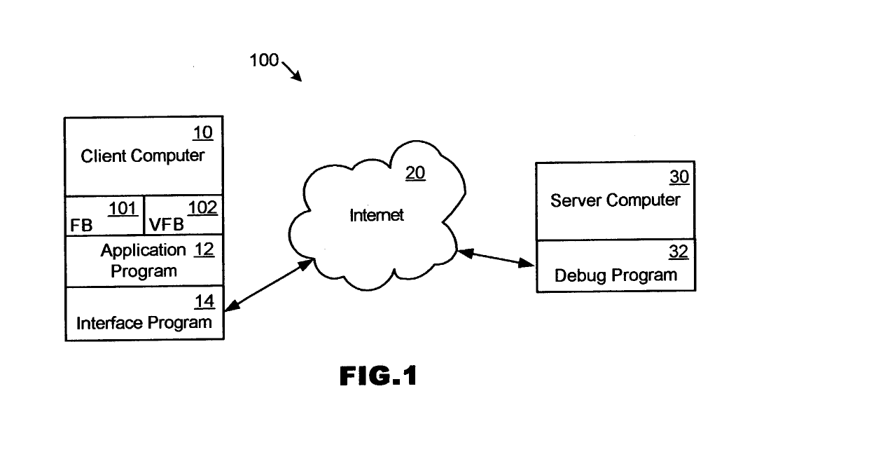

FIG. 1 illustrates a diagram of a system 100 for remotely debugging an application program 12 over the Internet 20. Included in the system 100 are a client computer 10 having an application program 12 and an interface program 14 residing on it, and a server computer 30 having a debug program 32 residing on it. A customer of the application program 12 controls the client computer 10, and a vendor of the application program 12 controls the server computer 30. The client computer 10 and the server computer 30 are coupled through the Internet 20. The debug program 32 facilitates preprogrammed and vendor debugging of the application program 12.

The interface program 14 controls the application program 12 and communicates with the debug program 32 during the debug mode. When the debug program 32 transmits a request to be acted upon by the application program 12, the interface program 14 receives the request and causes the application program 12 to generate a response to the request. The interface program 14 then transmits an indication of the response back to the debug program 32.

In one form of indication, the interface program 14 simply returns the response to the debug program 32. In another form of indication, the interface program 14 captures pixel information suitable for display on the display screen of the client computer 10 from either a frame buffer (“FB”) 101 or virtual frame buffer (“VFB”) 102 associated with the client computer 10, converts the pixel information into a graphics file of a selected graphics file format, and transmits the graphics file to the debug program 32. The graphics file format may be any one of a number of standard formats such as JPEG, GIF, TIF or PNG. This form of indication allows the vendor operator to see what is being displayed on the display screen of the client computer 10. This is especially useful when the vendor operator is unable to replicate the response generated by the application program 12 running on the client computer 10 with a corresponding response generated by a copy of the application program 12 running on the server computer 30.

As used herein, the purchaser of the application program 12 is referred to as the “customer”, the operator or user of the client computer 10 is referred to as the “customer operator”, the vendor company of the application program 12 is referred to as the “vendor”, and the operator or user of the server computer 30 is referred to as the “vendor operator”. Vendor operators are typically customer technical support personnel. The interface program 14 is typically sold or licensed by the vendor along with the application program 12.

The customer operator selects whether debugging of the application program 12 is to run in foreground or background mode. In foreground mode, the pixel information is stored in the frame buffer 101 and consequently, is displayed on the display screen of the client computer 10 since the display controller looks in this buffer to obtain what is to be displayed on the display screen. When debugging is performed in this mode, the interface program 14 captures the pixel information from the frame buffer 101 before generating the graphics file and transmitting it to the debug program 32 as described above. On the other hand, in background mode, the pixel information is stored instead in the virtual frame buffer 102 and consequently, is not displayed on the display screen of the client computer 10 since the display controller does not look in this buffer to obtain what is to be displayed on the display screen. When debugging is performed in this mode, the interface program 14 captures the pixel information from the virtual frame buffer 102 before generating the graphics file and transmitting it to the debug program 32 as described above.

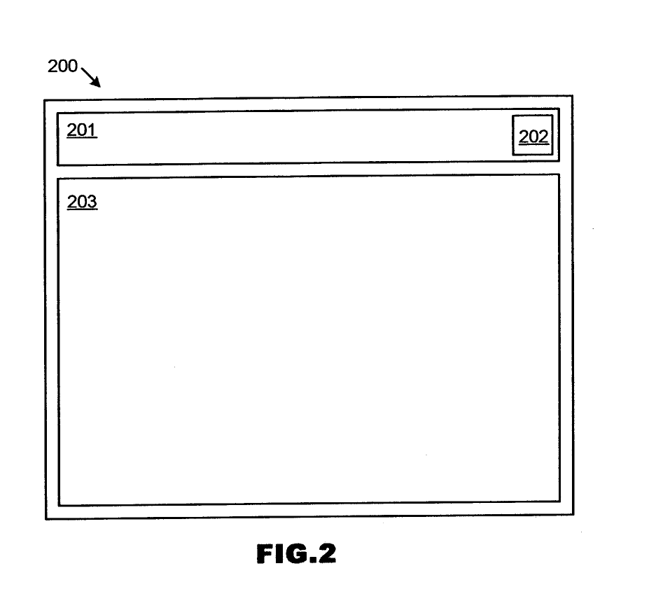

FIG. 2 illustrates a simplified example of the client display screen 200 under the control of the application program 12. A tool bar area 201 includes numerous buttons (not shown) for typical customer operator control input, and a debug button 202. The interface program 14 is activated when the customer operator clicks the debug button 202. Upon its activation, the interface program 14 takes control of the application program 12, establishes a connection with the debug program 32, receives requests from the debug program 32, and transmits responses or indications of responses back to the debug program 32. A client work area 203 is also shown on the client display screen 200. The tool bar area 201 and the client work area 203 are legacies of the application program 12, whereas the debug button 202 facilitates an added feature for remotely debugging the application program 12 over the Internet 20.

Another button that may be provided in the tool bar area 201 is a button for indicating whether debugging of an application program is to run in foreground mode or background mode. For example, if the customer operator does not click on this button, then debugging is to run in foreground mode and consequently, the interface program 14 causes pixel information generated by the application program 12 to be stored in the frame buffer 101 so that it may be displayed on the display screen of the client computer 10 during debugging of the application program 12. On the other hand, if the customer operator clicks on this button, then debugging is to run in background mode and consequently, the interface program 14 causes pixel information generated by the application program 12 to be stored in the virtual frame buffer 102 so that it is not displayed on the display screen of the client computer 10 during debugging of the application program 12.

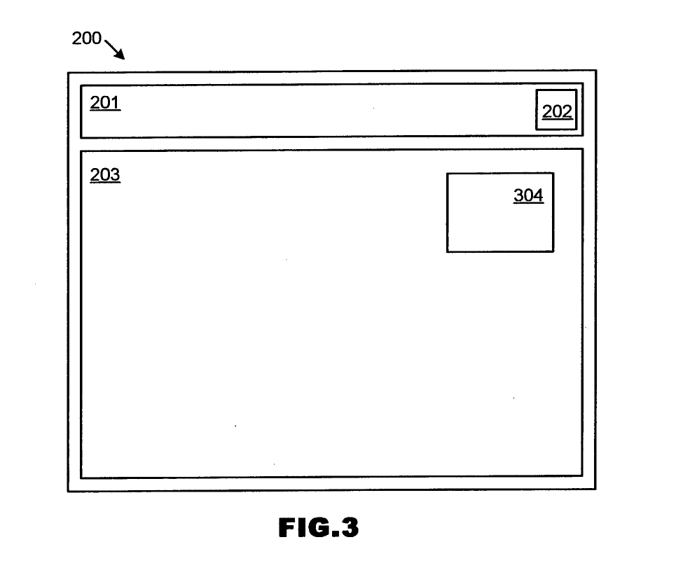

FIG. 3 illustrates a simplified example of the client display screen 200 under the control of the interface program 14. The tool bar area 201 is generally no longer responsive to customer operator input, except for the debug button 202. When the customer operator clicks the debug button 202 in this case, the interface program 14 is deactivated and control of the application program 12 returns to the customer operator. Superimposed over the client work area 203 is an exemplary window 304 used for communications between the customer operator and the debug program 32 or a vendor operator.

In one use of the window 304, the interface program 14 prompts the customer operator for a user identification and password. After the customer operator provides the requested information, the interface program 14 transmits the user identification and password to the debug program 32 for verification. In another use of the window 304, the interface program 14 presents a check-the-box type questionnaire to the customer operator to facilitate efficient diagnosis of the problem to be debugged. After the customer operator clicks the appropriate boxes, the interface program 14 transmits the information to the debug program 32, which in turn, initiates appropriate diagnostic sequences corresponding to each checked box. In still another use of the window 304, an instant messaging or chat room type area facilitates communication back and forth between the customer operator and the vendor operator to further facilitate diagnosis of the problem to be debugged.

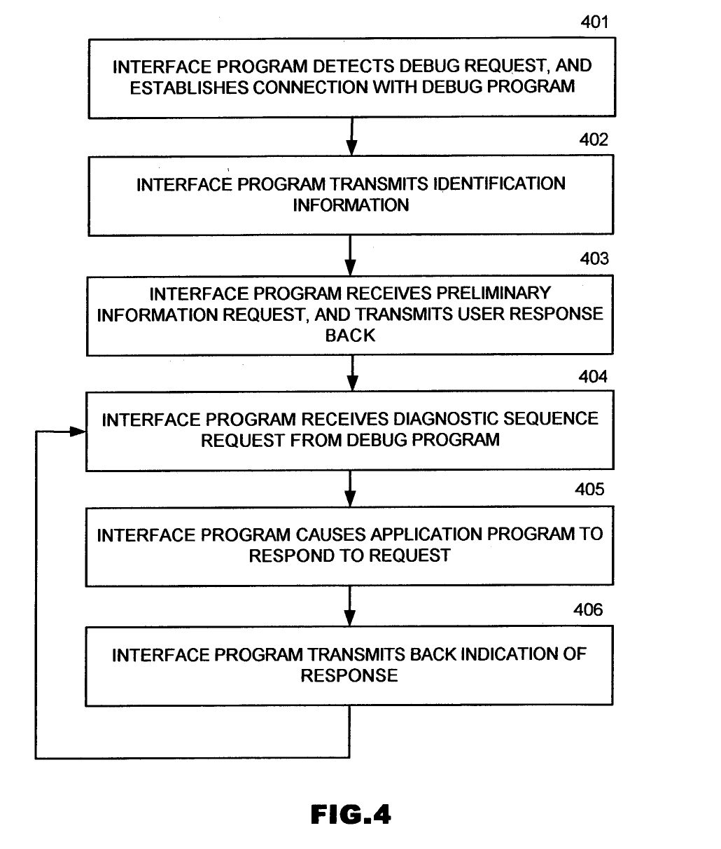

FIG. 4 illustrates a flow diagram of a method implemented in a client computer 10 for remotely debugging an application program 12 over the Internet 20. In 401, the interface program 14 detects a debug request initiated by the customer operator clicking the debug button 202, and as a result, becomes activated. After becoming activated, the interface program 14 takes control of the application program 12 and establishes a connection with the debug program 32 of the server computer 30 over the Internet 20. The interface program 14 knows the Internet address of the debug program 32 in this case, because it has been preprogrammed into the interface program 12 by the vendor.

In 402, the interface program 14 transmits identification information to the debug program 32 of the server computer 30 over the Internet 20. A first set of identification information includes identification of the application program 12, and identification of the client computer 10. This information allows the debug program 32 to verify that the application program 12 is still under warranty or maintenance contract, and that the client computer 10 is authorized to run the application program 12. The identifications of the application program and client computer 10 may be sent automatically by the interface program 14 according to its programming after establishing connection with the debug program 32, or sent by the interface program 14 after the debug program 32 has made a request for such information to the interface program 14. A second set of identification information includes a user identification and a password. The customer operator provides this information in a conventional fashion after being prompted by the interface program 14. Providing the user identification and password allows the debug program 32 to verify that the customer operator is authorized to contact the vendor company for debug support. If verification fails for either the first or second set of identification information, the interface program 14 displays a failure message received from the debug program 32 in the window 304. The interface program 14 is then deactivated, and control of the application program 12 is passed back to the customer operator.

In 403, the interface program 14 receives a request for preliminary information from the debug program 32. The preliminary information request may take the form of a fill-in-the-box questionnaire preprogrammed in and automatically transmitted by the debug program 32, or instant messaging or chat room type questions from the vendor operator. In either case, the questionnaire or questions are displayed in the window 304. The customer operator then responds to the questionnaire by checking the appropriate boxes, or answers the instant messaging or chat room type questions, as the case may be, and the interface program 14 transmits the information back to the debug program 32. The purpose of such preliminary information is to make the debug process more efficient, such as narrowing the choices of diagnostic sequences to take in subsequent debugging activities.

In 404 through 406, the interface program 14 takes certain actions in response to a diagnostic sequence received from the debug program 32. The diagnostic sequence may be preprogrammed into the debug program 32, or it may be provided to the debug program 32 from the vendor operator. It may also be a combination of a preprogrammed diagnostic sequence and vendor operator provided diagnostic sequence. In this case, the diagnostic sequence typically starts out as a preprogrammed diagnostic sequence that is paused at some point by the vendor operator. The vendor operator then takes over control of the debug program 32 at this point, and generates his or her own diagnostic sequence so as to interactively debug the application program 12.

In 404, the interface program 14 receives a request from the debug program 32 to be redirected to the application program 12. As previously described, the request is one of a diagnostic sequence directed to debug the application program 12. In 405, the interface program 14 causes the application program 12 to generate a response to the request. In 406, the interface program 14 transmits an indication of the response back to the debug program 32. As previously described, the indication may be the response itself, or a graphics file including pixel information suitable for display on the display screen of the client computer 10. Then 404 through 406 are repeated multiple times so as to run the application program 12 through the diagnostic sequence.

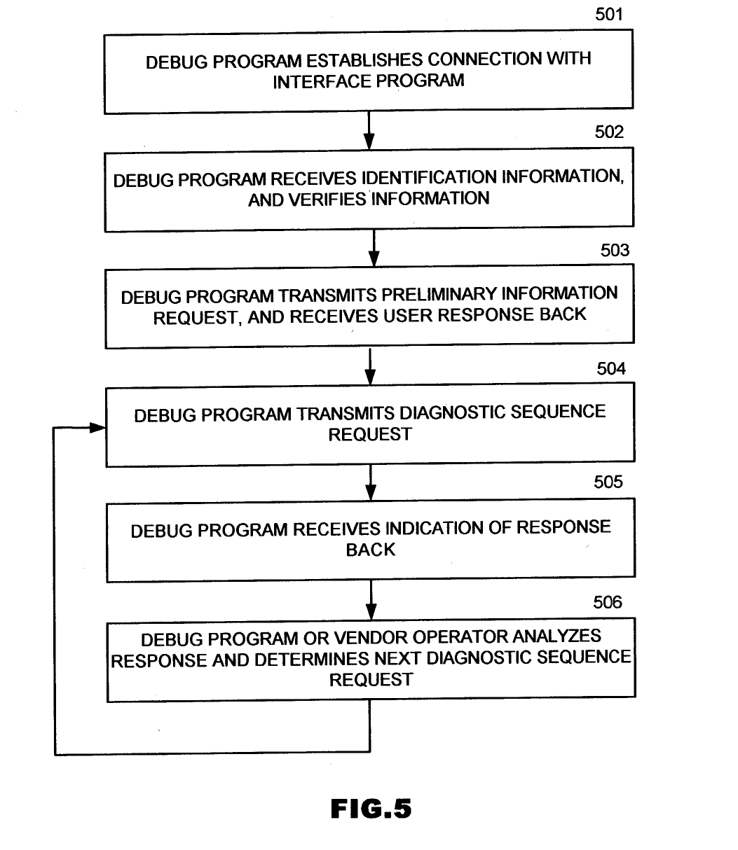

FIG. 5 illustrates a flow diagram of a method implemented in a server computer 30 for remotely debugging an application program 12 over the Internet 20. In 501, the debug program 32 establishes a connection with the interface program 14 of the client computer 10, as further described in reference to 401. In 502, the debug program 32 receives identification information from the interface program 14, and verifies such information, as further described in reference to 402. In 503, the debug program 32 transmits a preliminary information request to the interface program 14, and receives customer operator responses back, as further described in reference to 403. By performing 504 through 506 multiple times, the debug program 32 or vendor operator generates and provides the diagnostic sequence to the interface program 14 in order to debug the application program 12, as further described in reference to 404 through 406. In particular, in 504, the debug program 32 transmits a diagnostic sequence request for the application program 12 to the interface program 14. In 505, the debug program 32 receives an indication of the response of the application program 12 to the diagnostic sequence request back from the interface program 14. In 506, the debug program 32 analyzes the response and determines a next diagnostic sequence request for the application program 12 according to a preprogrammed diagnostic sequence, or the vendor operator analyzes the response and determines a next diagnostic sequence request for the application program 12 according to a vendor operator determined diagnostic sequence.

Although the various aspects of the present invention have been described with respect to a preferred embodiment, it will be understood that the invention is entitled to full protection within the full scope of the appended claims.

We claim:

1. A method for debugging an application program, comprising:
(a) receiving a request from a debug program;
(b) causing an application program to generate pixel information suitable for a display screen in response to said request;
(c) storing said pixel information in a virtual frame buffer so as not to be displayed on said display screen;
(d) generating a graphics file from said pixel information; and
(e) transmitting said graphics file to said debug program for processing.

2. The method according to claim 1, further comprising repeating (a) through (e) multiple times so as to run said application program through a diagnostic sequence.

3. The method according to claim 2, wherein said diagnostic sequence is provided to said debug program by a user of a computer running said debug program.

4. The method according to claim 2, wherein said diagnostic sequence is preprogrammed into said debug program.

5. The method according to claim 1, further comprising prior to (a), detecting a debug request initiated by a user of a first computer running said application program.

6. The method according to claim 1, further comprising prior to (a), transmitting identifications of said application program and a first computer running said application program.

7. The method according to claim 1, further comprising prior to (a), transmitting a user identification and a password provided by a user of a first computer running said application program.

8. The method according to claim 1, wherein said application program runs on a first computer, said debug program runs on a second computer, and said first computer and said second computer communicate through the Internet.

9. The method according to claim 8, further comprising prior to (a), establishing a secure communication channel between said first computer and said second computer.

10. The method according to claim 1, wherein said graphics file is in a GIF format.

11. The method according to claim 1, wherein said graphics file is in a JPEG format.

12. The method according to claim 1, wherein said graphics file is in a TIF format.

13. The method according to claim 1, wherein said graphics file is in a PNG format.

14. An apparatus for debugging an application program, comprising a first computer including an interface program configured to:
(a) receive a request from a debug program;
(b) cause an application program to generate pixel information suitable for a display screen of said first computer in response to said request;
(c) store said pixel information in a virtual frame buffer of said first computer so as not to be displayed on said display screen;
(d) generate a graphics file from said pixel information; and
(e) transmit said graphics file to said debug program for processing.

15. The apparatus according to claim 14, wherein said application program runs on said first computer, and said debug program runs on a second computer.

16. The apparatus according to claim 15, wherein said first computer and said second computer communicate through the Internet.

17. The apparatus according to claim 16, wherein said interface program is further configured to establish a secure communication channel between said first computer and said second computer prior to performing (a).

18. The apparatus according to claim 17, wherein said secure communication channel employs a secure sockets layer protocol.

19. The apparatus according to claim 17, wherein said interface program is further configured to transmit to said second computer, identifications of said application program and said first computer after establishing said secure communication channel.

20. The apparatus according to claim 17, wherein said interface program is further configured to transmit to said second computer, an user identification and a password provided by a user of said first computer, after establishing said secure communication channel.

21. The apparatus according to claim 14, wherein said interface program is further configured to repeat (a) through (e) multiple times so as to run said application program through a diagnostic sequence.

22. The apparatus according to claim 19, wherein said diagnostic sequence is provided to said debug program by a user of said second computer.

23. The apparatus according to claim 19, wherein said diagnostic sequence is preprogrammed into said debug program.

24. The apparatus according to claim 14, wherein said interface program is further configured to detect a debug request initiated by a user of said first computer prior to performing (a).
